(19) United States
(12) Patent Application Publication
(10) Pub. No.: US 2006/0279582 A1
(43) Pub. Date: Dec. 14, 2006

(54) COLOR MANAGEMENT METHOD CAPABLE OF TRANSFORMING COLOR COORDINATES BETWEEN DIFFERENT COLOR SPACES

(76) Inventor: Wen-Hung Hsieh, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,875

(22) Filed: Jul. 13, 2005

(30) Foreign Application Priority Data
Jun. 10, 2005 (TW) 094119169

(51) Int. Cl. G09G 5/02

(52) U.S. Cl. 345/604

(57) ABSTRACT

A color management method transforms color coordinates between devices that use different color spaces by finding a plurality of weightings in an intermediate color space. The method can transform color coordinates of a pixel from the color space of a display device to the color space of a printing device, or from the color space of the printing device to the color space of the display device. The color management method provides cross-media color matching so that a pixel displayed by different devices has the same color characteristics.

### BACKGROUND OF THE INVENTION

1. Field of the Invention

The present invention relates to a color management method, and more particularly, to a color management method capable of transforming color coordinates between different color spaces.

2. Description of the Prior Art

An image processing system usually includes an image input device, an image output device, and a color management module (CMM). The image input device sends image data to the color management module, which in turn processes the received image data and then sends the processed data to the image output device. Based on the processed data, the image output device displays an image close to the original image. Image input devices include optical scanners, digitals cameras, digital videos, etc. Image output devices include various kinds of printers, drawing instruments and displays. The color manage modules can be general-use computers that control peripheral devices and perform image processing with the software installed on them.

Different image devices can adopt different color models. A color model is a multiple-dimensional color space that represents all colors perceivable by human eyes. Common color models are RGB (red, green, blue) and CMYK (cyan, magenta, yellow, black) color models. Computers and televisions usually adopt the RGB color model in which their color spaces are formed with different proportions of the red, green and blue colors, while printers usually adopt the CMYK model. Cubes, cones or polyhedrons are commonly used for illustrating color spaces. Color spaces can be categorized into two main types: device-dependent color spaces and device-independent color spaces. Since each image device has its own unique color characteristics, even image devices of the same brand that adopt the same color space can feature different color effects. The RGB and CMYK color spaces belong to device-dependent color spaces. Device-independent color spaces, such as CIEXYZ, CIE xyz, CIELAB and CIELUV, belong to color coordinate systems established by the International Commission on Illumination (CIE) and image data represented by a device-independent color space does not vary from device to device.

Images generated by different devices do not necessarily have the same color signals. For devices that adopt the same device-dependent color space, displaying the same set of color coordinates can result in different images. Therefore, color management modules are required for image processing that allows accurate and proper expressions of the same image between different devices.

### SUMMARY OF THE INVENTION

It is therefore a primary objective of the claimed invention to provide a color management method capable of transforming color coordinates between different color spaces.

The claimed invention discloses a color management method comprising the following steps: (a) acquiring color coordinates of a pixel generated by a display device; (b) among a plurality of color coordinates in an intermediate color space, acquiring color coordinates which are closest to the color coordinates acquired in step (a); (c) generating a plurality of weightings based on the color coordinates acquired in step (a) and a plurality of intermediate color coordinates neighboring the color coordinates acquired in step (b); (d) generating a plurality of color coordinates of a printing device corresponding to the plurality of intermediate color coordinates; (e) generating color coordinates based on the plurality of weightings and the plurality of color coordinates generated in step (d); and (f) printing the pixel based on the color coordinates generated in step (e).

The claimed invention also discloses another color management method comprising the following steps: (a) acquiring color coordinates of a pixel generated by a printing device; (b) among a plurality of color coordinates in an intermediate color space, acquiring color coordinates which are closest to the color coordinates acquired in step (a); (c) generating a plurality of weightings based on the color coordinates acquired in step (a) and a plurality of intermediate color coordinates neighboring the color coordinates acquired in step (b); (d) generating a plurality of color coordinates of a display device corresponding to the plurality of intermediate color coordinates; (e) generating color coordinates based on the plurality of weightings and the plurality of color coordinates generated in step (d); and (f) displaying the pixel based on the color coordinates generated in step (e).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a color space of a display device.

FIG. 2 shows an intermediate three-dimensional interpolation table established from the color space in FIG. 1.

FIG. 3 shows an intermediate three-dimensional interpolation table of a display device.

FIGS. 4-9 are diagrams illustrating tetrahedrons constructing sub-intermediate color spaces of the display device.

FIG. 10 shows an intermediate three-dimensional interpolation table of a printing device.

FIGS. 11-16 are diagrams illustrating tetrahedrons constructing sub-intermediate color spaces of the printing device.

### DETAILED DESCRIPTION

To explain the present invention, suppose a display device adopts a device-dependent RGB color space and describes a pixel using R, G, B coordinates, an intermediate color space (such as an sRGB color space) describes a pixel using R″, G″, B″ coordinates, and a printing device also adopts a device-dependent RGB color space and describes a pixel using R′, G′, B′ coordinates. Since the RGB color space is device-dependent, a same set of color coordinates can feature different color characteristics on the display and printing devices. Therefore, a color management module is required for transforming color coordinates between color spaces. Based on the color coordinates of a pixel described by the display device, the color management module generates the corresponding color coordinate in the color space of the printing device. Based on the corresponding color coordinates generated by the color image module, the printing device can print the pixel with the same color characteristics as when the pixel is displayed by the display device.

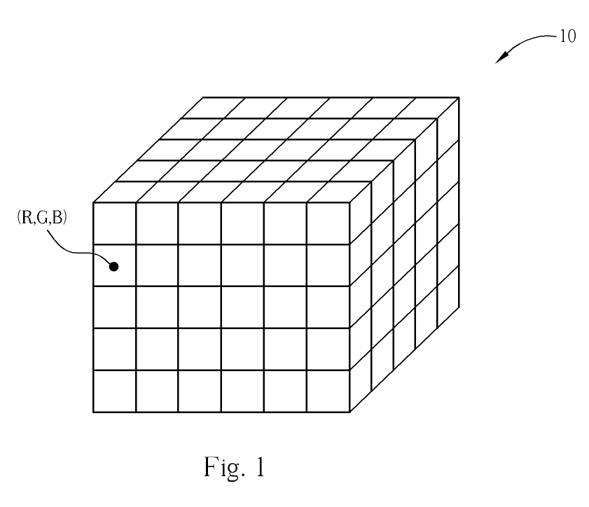

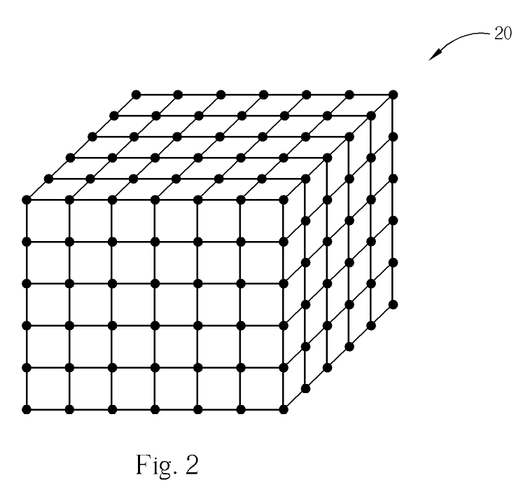

Please refer to FIG. 1 for a color space 10 of a display device. A pixel P to be printed is represented by a set of color coordinates (R, G, B) in the color space 10. The color coordinates (R, G, B) represent red, green and blue components of the pixel P in the color space 10. Please refer to FIG. 2 for an intermediate three-dimensional interpolation table 20 established from the color space 10 through calorimetric measurement. The intermediate three-dimensional interpolation table 20 has similar structure as the color space 10, but further includes a plurality of reference coordinates, represented by the dots in FIG. 2. If the color space 10 is device-dependent, then intermediate three-dimensional interpolation tables established from different devices adopting the same color space 10 can include different reference coordinates. For example, if a display device and a printing device both adopt the color space 10, their corresponding intermediate three-dimensional interpolation tables have identical structure, but include different reference coordinates.

The present invention can transform color coordinates of a pixel from the color space of a display device to the color space of a printing device. Firstly, the pixel P, represented by the set of color coordinate (R, G, B) in the color space 10, is mapped to an intermediate color space (such as an sRGB color space) and represented by color coordinates (iR, iG, iB) in the intermediate color space. Based on the color coordinates (iR, iG, iB), reference coordinates (R″, G″, B″), which are closest to the color coordinates (iR, iG, iB), are obtained in an intermediate three-dimensional interpolation table of the display device.

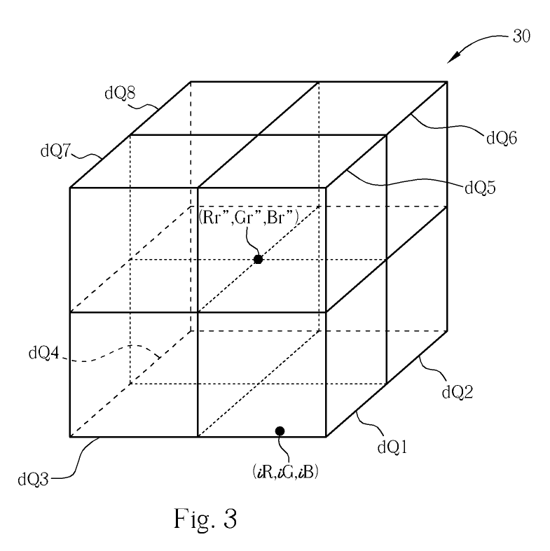

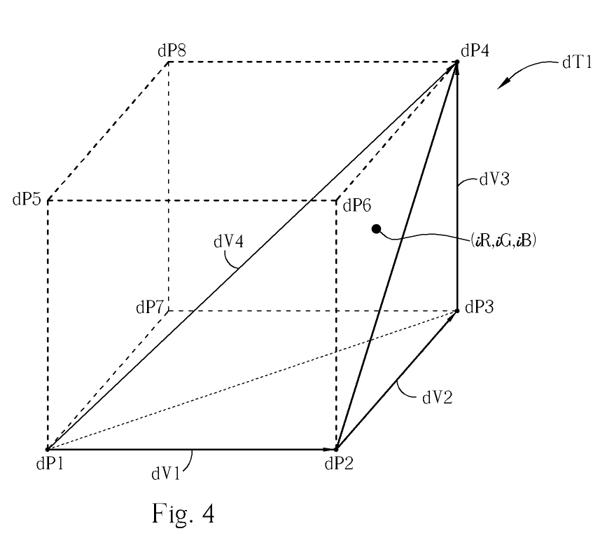

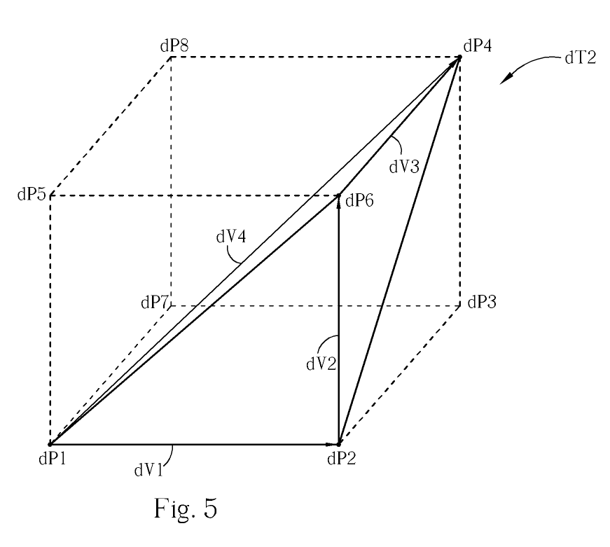

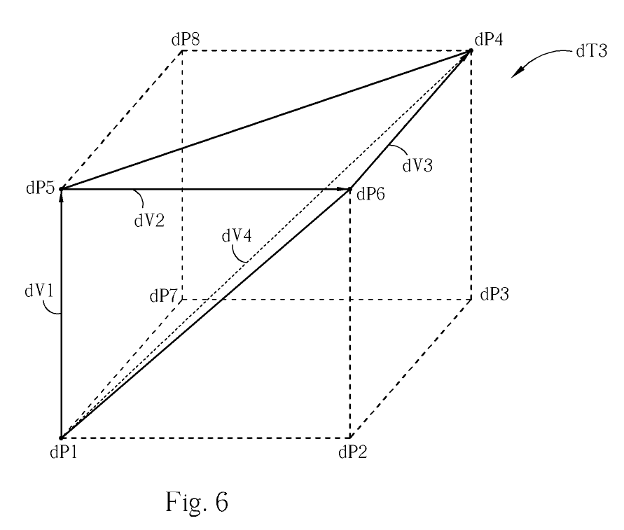

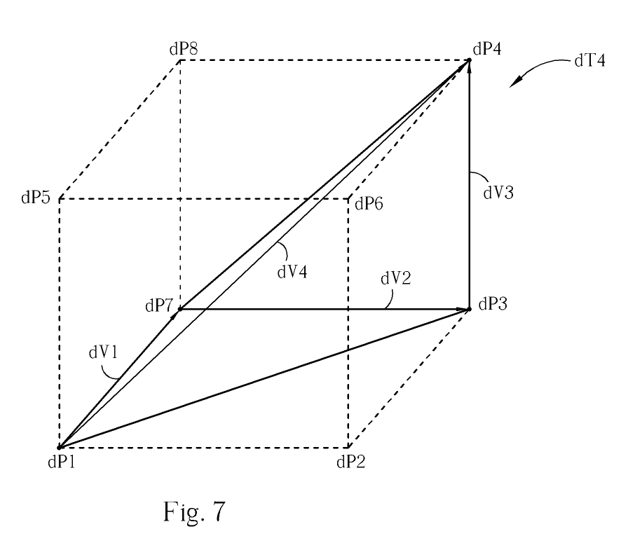

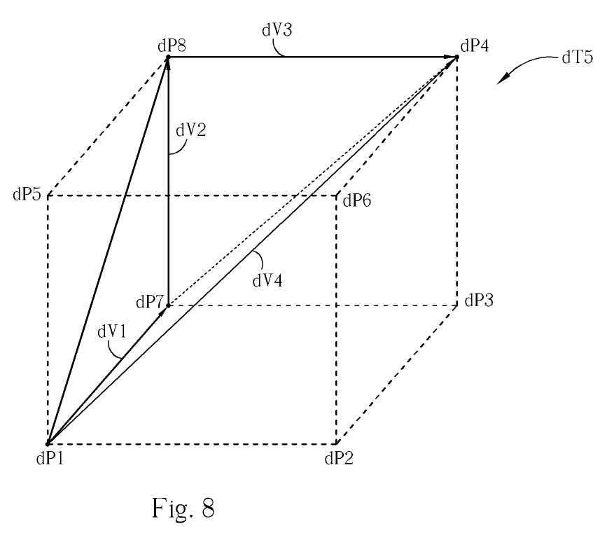

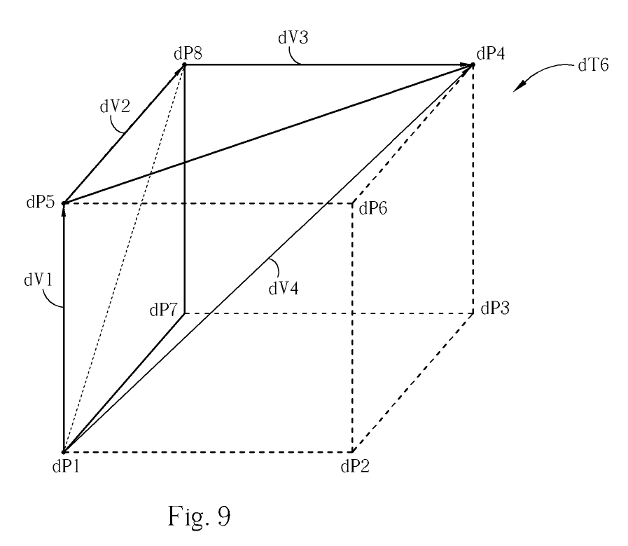

Please refer to FIG. 3 through FIG. 9 for diagrams illustrating the method of obtaining the color coordinates (iR, iG, iB). FIG. 3 represents an intermediate three-dimensional interpolation table 30 of the display device. Each of the sub-intermediate color spaces dQ1-dQ8 includes six tetrahedrons dT1-dT6, illustrated in FIG. 4 through FIG. 9 respectively. Suppose the color coordinates (iR, iG, iB) are located within the sub-intermediate color spaces dQ1. Depending on red (R), green (G) and blue (B) components, the color coordinates (iR, iG, iB) and the sub-intermediate color space dQ1 have the following relationships:

(1) G>B>R: the color coordinates (iR, iG, iB) correspond to the tetrahedron dT1 of the sub-intermediate color spaces dQ1;

(2) G>R>B: the color coordinates (iR, iG, iB) correspond to the tetrahedron dT2 of the sub-intermediate color spaces dQ1;

(3) R>G>B: the color coordinates (iR, iG, iB) correspond to the tetrahedron dT3 of the sub-intermediate color spaces dQ1;

(4) B>G>R: the color coordinates (iR, iG, iB) correspond to the tetrahedron dT4 of the sub-intermediate color spaces dQ1;

(5) B>R>G: the color coordinates (iR, iG, iB) correspond to the tetrahedron dT5 of the sub-intermediate color spaces dQ1;

(6) R>B>G: the color coordinates (iR, iG, iB) correspond to the tetrahedron dT6 of the sub-intermediate color spaces dQ1;

Please refer to FIG. 4. If the color coordinates (R, G, B) of the pixel P in the color space 10 of the display device are mapped to the tetrahedron dT1 of the sub-intermediate color spaces dQ1, the color coordinates (iR, iG, iB) can be represented by vectors dV1-dV4 formed by four apices dP1-dP4 of the tetrahedron dT1. The vectors dV1-dV4, defined by apices dP1 and dP2, apices dP2 and dP3, apices dP3 and dP4, and apices dP1 and dP4 respectively, include the red, green and blue components of the tetrahedron dT1. The color coordinates (iR, iG, iB) and the vectors dV1-dV4 have the following relationships:
iR=w1*R1″+w2*R2″+w3*R3″+w4*R4″
iG=w1*G1″+w2*G2″+w3*G3″+w4*G4″
iB=w1*B1″+w2*B2″+w3*B3″+w4*B4″

where

R1″-R4″ represent the red components of the vectors dV1-dV4 of the tetrahedron dT1 in the intermediate three-dimensional interpolation table 30 of the display device, respectively;

G1″-G4″ represent the green components of the vectors dV1-dV4 of the tetrahedron dT1 in the intermediate three-dimensional interpolation table 30 of the display device, respectively;

B1″-B4″ represent the blue components of the vectors dV1-dV4 of the tetrahedron dT1 in the intermediate three-dimensional interpolation table 30 of the display device, respectively;

w1-w4 represent weightings with which the color coordinates (iR, iG, iB) are represented by the vectors dV1-dV4, and w1+w2+w3+w4=1.

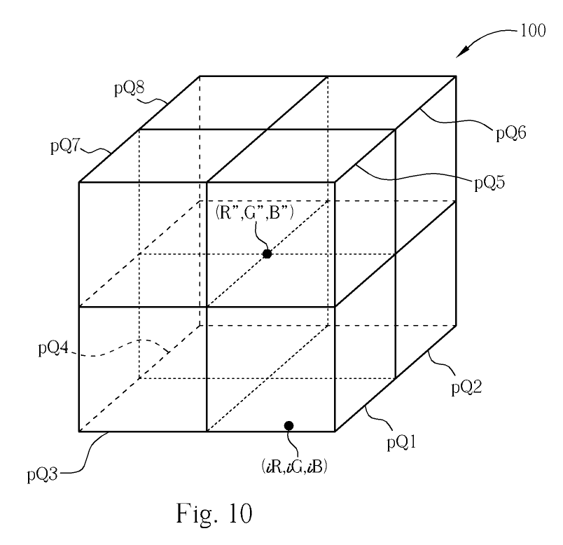

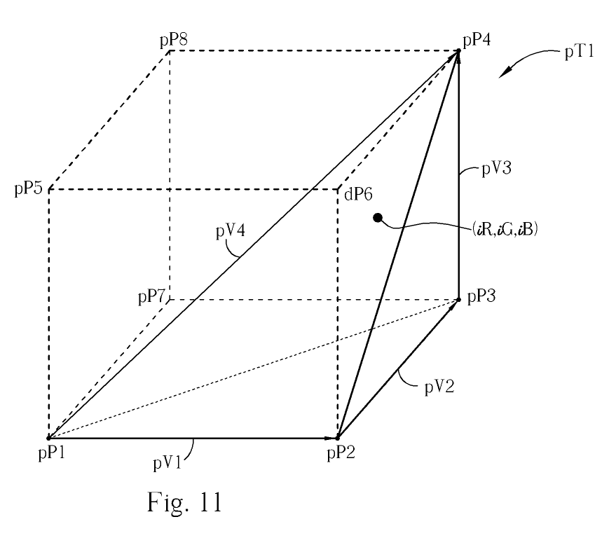

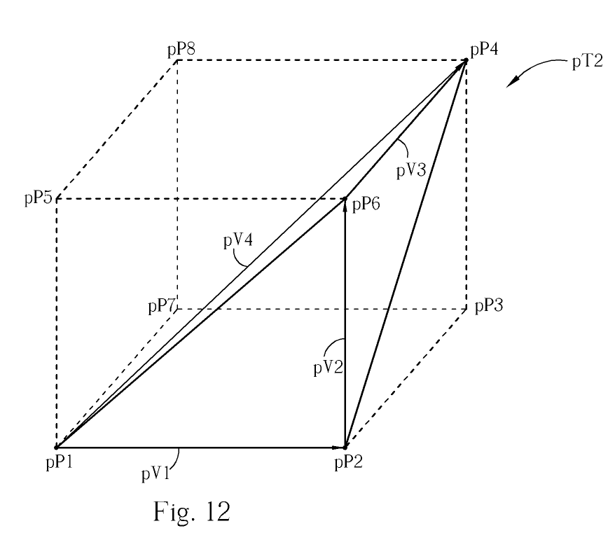

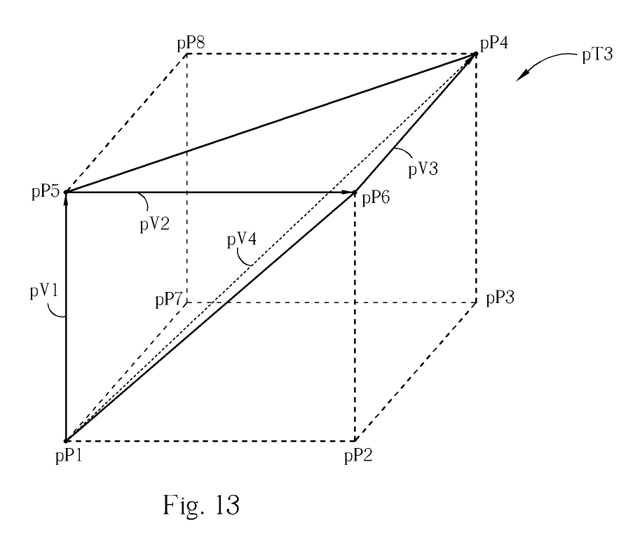

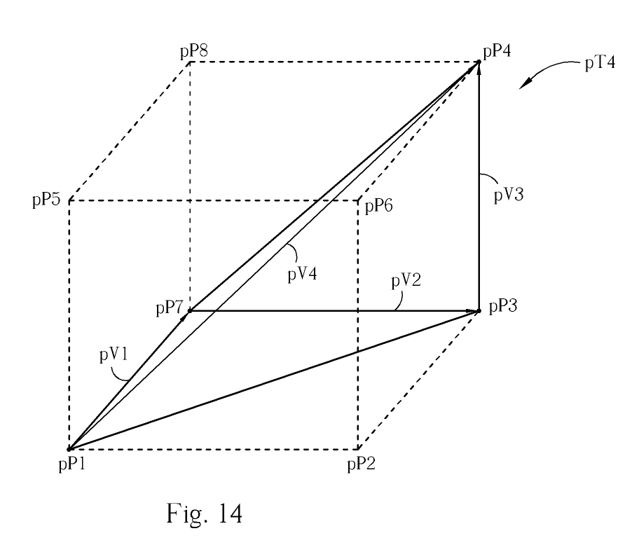

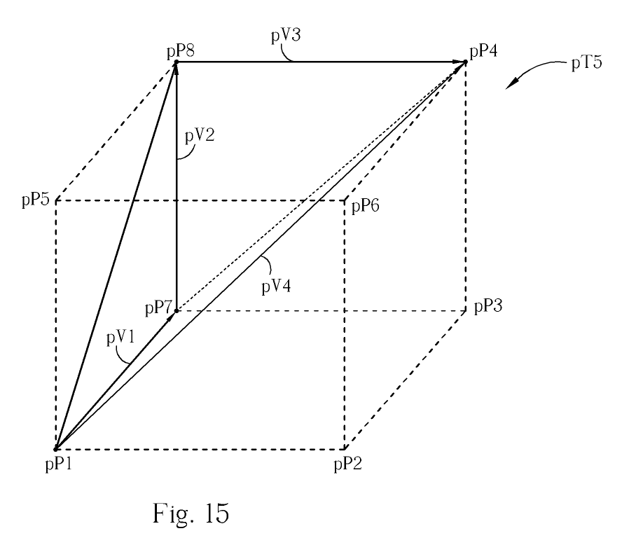

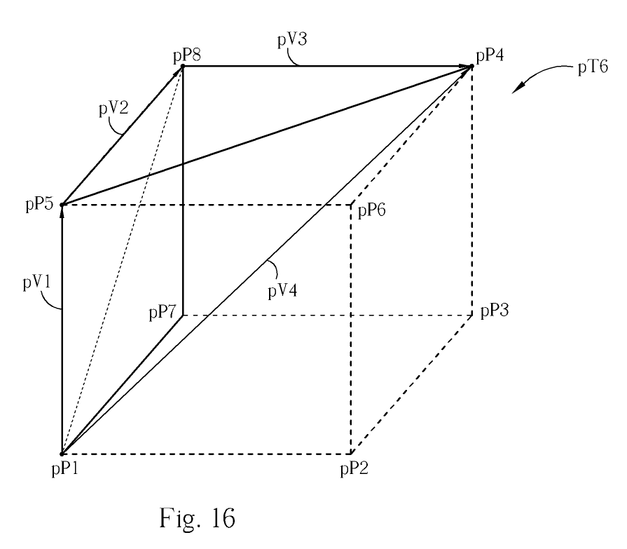

After obtaining the color coordinates (iR, iG, iB) in the intermediate three-dimensional interpolation table 30 based on the color coordinates (R, G, B) in the color space 10, a set of color coordinates (R″, G″, B″) that is closest to the color coordinates (iR, iG, iB) is acquired in the intermediate three-dimensional interpolation table 30. Please refer to FIG. 10 for a detailed structure of an intermediate three-dimensional interpolation table 100 of a printing device. The intermediate three-dimensional interpolation table 100 of the printing device includes eight sub-intermediate color spaces pQ1-pQ8. Each of the sub-intermediate color spaces pQ1-pQ8 includes six tetrahedrons pT1-pT6 defined by four of the eight apices pP1-pP8 of each sub-intermediate color space. The tetrahedrons pT1-pT6 are illustrated in FIG. 11 through FIG. 16, respectively. The present invention starts with the color coordinates (R″, G″, B″) in the intermediate three-dimensional interpolation table 100, acquires a plurality of weightings α1-α4 by trial and error, and represents the color coordinates (iR, iG, iB) as follows:
iR=α1*R1″+α2*R2″+α3*R3″+α4*R4″
iG=α1*G1″+α2*G2″+α3*G3″+α4*G4″
iB=α1*B1″+α2*B2″+α3*B3″+α4*B4″

where

R1″-R4″ represent the red components of the vectors pV1-pV4 of the tetrahedron pT1 in the intermediate three-dimensional interpolation table 100 of the display device, respectively;

G1″-G4″ represent the green components of the vectors pV1-pV4 of the tetrahedron pT1 in the intermediate three-dimensional interpolation table 100 of the display device, respectively;

B1″-B4″ represent the blue components of the vectors pV1-pV4 of the tetrahedron pT1 in the intermediate three-dimensional interpolation table 100 of the display device, respectively;

α1-α4 represent the weightings with which the color coordinates (iR, iG, iB) are represented by the vectors pV1-pV4, and α1+α2+α3+α4=1.

Based on R1″-R4″, G1″-G4″ and B1″-B4″, corresponding R1′-R4′, G1′-G4′ and B1′-B4′ are generated in the color space of the printing device. Based on R1′-R4′, G1′-G4′, B1′-B4′ and the weightings α1-α4, target color coordinates (R′, G′, B′) of the pixel P can be obtained in the color space of the printing device. The target color coordinates (R′, G′, B′) represent color coordinates when the color coordinates (R, G, B) are mapped from the color space 10 of the display device to the color space of the printing device, and can be represented as follows:
R′=α1*R1′+α2*R2′+α3*R3′+α4*R4′
G′=α1*G1′+α2*G2′+α3*G3′+α4*G4′
B′=α1*B1′+α2*B2′+α3*B3′+α4*B4′

where α1+α2+α3+α4=1

Therefore, based on the target color coordinates (R′, G′, B′), the printing device can express the pixel P with the same characteristics as expressed by the display device based on the color coordinates (R, G, B).

The intermediate three-dimensional interpolation tables 30 and 100 illustrated in FIG. 3 through FIG. 10 are sRGB color spaces. The present invention can also adopt other color spaces, such as RGB, Photo YCC or Adobe RGB, for the intermediate three-dimensional interpolation tables 30 and 100.

The present invention can also transform color coordinates of a pixel from the color space of a printing device to the color space of a display device. Firstly, the pixel P′, represented by the set of color coordinate (Rr′, Gr′, Br′) in the color space of the printing device, is mapped to the intermediate three-dimensional interpolation table 100 of the printing device and represented by color coordinates (iRr′, iGr′, iBr′) in the intermediate color space. Then based on the color coordinates (iRr′, iGr′, iBr′), reference coordinates (Rr″, Gr″, Br″), which are closest to the color coordinates (iRr′, iGr′, iBr′), are obtained in the intermediate three-dimensional interpolation table 30 of the display device.

As shown in FIG. 3, the intermediate three-dimensional interpolation table 30 of the display device includes eight sub-intermediate color spaces dQ1-dQ8 centered around color coordinates (Rr″, Gr″, Br″). Each of the sub-intermediate color spaces dQ1-dQ8 includes six tetrahedrons dT1-dT6 defined by four of the eight apices dP1-dP8 of each sub-intermediate color space. The tetrahedrons dT1-dT6 are illustrated in FIG. 4 through FIG. 9, respectively. The present invention starts with the color coordinates (Rr″, Gr″, Br″) in the intermediate three-dimensional interpolation table 30 and acquires color coordinates (iRr′, iGr′, iBr′) in the intermediate three-dimensional interpolation table 30 by trial and error. The color coordinates (iRr′, iGr′, iBr′) correspond to color coordinates when the color coordinates (Rr′, Gr′, Br′) are mapped from the color space of the printing device to the intermediate three-dimensional interpolation table 30. Suppose the color coordinates (iRr′, iGr′, iBr′) are located within the tetrahedron dT1 of the sub-intermediate color spaces dQ1, the color coordinates (iRr′, iGr′, iBr′) can be represented by the vectors dV1-dV4 formed by the four apices dP1-dP4 of the tetrahedron dT1. The present invention acquires a plurality of weightings β1-β4 by trial and error and represents the color coordinates (iRr′, iGr′, iBr′) as follows:
iRr′=β1*R1″+β2*R2″+β3*R3″+β4*R4″
iGr′=β1*G1″+β2*G2″+β3*G3″+β4*G4″
iBr′=β1*B1″+β2*B2″+β3*B3″+β4*B4″

where

R1″-R4″ represent the red components of the vectors dV1-dV4 of the tetrahedron dT1 in the intermediate three-dimensional interpolation table 30 of the display device, respectively;

G1″-G4″ represent the green components of the vectors dV1-dV4 of the tetrahedron dT1 in the intermediate three-dimensional interpolation table 30 of the display device, respectively;

B1″-B4″ represent the blue components of the vectors dV1-dV4 of the tetrahedron dT1 in the intermediate three-dimensional interpolation table 30 of the display device, respectively;

β1-β4 represent the weightings with which the color coordinates (iRr′, iGr′, iBr′) are represented by the vectors dV1-dV4, and β1+β2+β3+β4=1.

Based on R1″-R4″, G1″-G4″ and B1″-B4″, corresponding R1-R4, G1-G4 and B1-B4 are generated in the color space of the display device. Based on R1-R4, G1-G4, B1-B4 and the weightings β1-β4, target color coordinates (Rr, Gr, Br) of the pixel P′ can be obtained in the color space of the display device. The target color coordinates (Rr, Gr, Br) represent color coordinates when the color coordinates (Rr′, Gr′, Br′) are mapped from the color space of the printing device to the color space of the display device, and can be represented as follows:
Rr=β1*R1+β2*R2+β3*R3+β4*R4
Gr=β1*G1+β2*G2+β3*G3+β4*G4
Br=β1*B1+β2*B2+β3*B3+β4*B4

where β1+β2+β3+β4=1

Therefore, based on the target color coordinates (Rr, Gr, Br), the display device can express the pixel P′with the same characteristics as expressed by the printing device based on the color coordinates (Rr′, Gr′, Br′).

In conclusion, the present invention provides a color management method capable of transforming color coordinates between devices that use different color spaces by finding a plurality of weightings in an intermediate color space. The present invention provides cross-media color matching so that a pixel displayed by different devices has the same color characteristics.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A color management method capable of transforming color coordinates between different color spaces, the method comprising the following steps:
(a) acquiring color coordinates of a pixel generated by a display device;
(b) among a plurality of color coordinates in an intermediate color space, acquiring color coordinates which are closest to the color coordinates acquired in step (a);
(c) generating a plurality of weightings based on the color coordinates acquired in step (a) and a plurality of intermediate color coordinates neighboring the color coordinates acquired in step (b);
(d) generating a plurality of color coordinates of a printing device corresponding to the plurality of intermediate color coordinates;
(e) generating color coordinates based on the plurality of weightings and the plurality of color coordinates generated in step (d); and
(f) printing the pixel based on the color coordinates generated in step (e).

2. The method of claim 1 further comprising transforming the color coordinates of the pixel.

3. The method of claim 1 further comprising:
(g) acquiring the plurality of intermediate color coordinates neighboring the color coordinates acquired in step (b).

4. The method of claim 3 wherein step (g) acquires the plurality of intermediate color coordinates neighboring the color coordinates acquired in step (b) by trial and error.

5. The method of claim 3 wherein step (g) acquires four intermediate color coordinates neighboring the color coordinates acquired in step (b).

6. The method of claim 1 further comprising transforming the color coordinates generated in step (e), wherein step (f) prints the pixel based on the transformed color coordinates.

7. A color management method capable of transforming color coordinates between different color spaces, the method comprising the following steps:
(a) acquiring color coordinates of a pixel generated by a printing device;
(b) among a plurality of color coordinates in an intermediate color space, acquiring color coordinates which are closest to the color coordinates acquired in step (a);
(c) generating a plurality of weightings based on the color coordinates acquired in step (a) and a plurality of intermediate color coordinates neighboring the color coordinates acquired in step (b);
(d) generating a plurality of color coordinates of a display device corresponding to the plurality of intermediate color coordinates;
(e) generating color coordinates based on the plurality of weightings and the plurality of color coordinates generated in step (d); and
(f) displaying the pixel based on the color coordinates generated in step (e).

8. The method of claim 7 further comprising transforming the color coordinates of the pixel.

9. The method of claim 7 further comprising:
(g) acquiring the plurality of intermediate color coordinates neighboring the color coordinates acquired in step (b).

10. The method of claim 9 wherein step (g) acquires the plurality of intermediate color coordinates neighboring the color coordinates acquired in step (b) by trial and error.

11. The method of claim 9 wherein step (g) acquires four intermediate color coordinates neighboring the color coordinates acquired in step (b).

12. The method of claim 7 further comprising transforming the color coordinates generated in step (e), wherein step (f) displays the pixel based on the transformed color coordinates.
